(19) United States
(12) Patent Application Publication
(10) Pub. No.: US 2025/0348418 A1
(43) Pub. Date: Nov. 13, 2025

(54) OPEN RADIO ACCESS NETWORK TEST CASES AUTOMATIC TRANSLATION

(71) Applicant: Dell Products L.P., Round Rock, TX (US)

(72) Inventors: Marwan Mostafa Mahmoud Abdelmajeed, Cairo (EG); Ibrahim Elshiekh, Merghany (EG); Karim Mohamed, Cairo (EG); Mohamed Abouzeid, El Sheikh Zayed (EG); Ali Mohamed Youssef, Smouha (EG); Mahmoud Youssef, 3rd New Cairo (EG); Nour Mohamed Hussein Kamaly, Cairo (EG)

(21) Appl. No.: 18/662,180

(22) Filed: May 13, 2024

(51) Int. Cl. G06F 11/36; G06F 8/30

(52) U.S. Cl. CPC G06F 11/3688; G06F 8/30; G06F 11/3684

(57) ABSTRACT

Leveraging generative artificial intelligence and machine learning models to test, certify, and deploy open radio access network (ORAN) compliant networking equipment in a wireless communication network. An example method comprises receiving structured test case data, transforming the structured test case data into a generic executable programming language code representative of the structured test case data, and executing the generic executable programming language code using a machine language operations pipeline to ensure that network equipment represented in a testing framework of networking equipment complies with a specified networking protocol standard.

### BACKGROUND

Traditional radio access networks (RANs) provide integrated and closely coupled platform hardware and software. There is homogeneity with regard to the networking equipment vendor, and executable software products supplied by a network equipment vendor are generally only operable on networking equipment supplied by that network equipment vendor. For example, first network equipment manufactured and/or supplied by a first network equipment vendor is typically only operable with second network equipment that is also supplied by the same network equipment vendor. Thus, first base station equipment manufactured and/or supplied by a first network equipment manufacturer/vendor entity generally cannot be operatively and/or communicatively coupled with second base station equipment manufactured and/supplied by a disparate second network equipment manufacturer/vendor entity. Further, any executable software product supplied by a first network equipment manufacturer/vendor entity for execution on first base station equipment manufactured or supplied by the first network equipment manufacturer/vendor entity typically is incapable of being executed on second base station equipment manufactured/supplied by a second equipment manufacture/vendor entity. The executable software and the networking equipment on which the executable software was designed to execute are generally proprietary and closely tied to the networking equipment manufacturer/vendor entity.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a system for leveraging generative artificial intelligence and machine learning models to train groups of artificial intelligence models and machine learning models for use in testing, certifying, and deploying open radio access network (ORAN) compliant communication network infrastructures, in accordance with various non-limiting example embodiments.

FIG. 2 depicts a block diagram of a system for leveraging generative artificial intelligence and machine learning models to train groups of artificial intelligence models and machine learning models for use in testing, certifying, and deploying ORAN compliant communication network infrastructures, in accordance with various non-limiting example embodiments.

FIG. 3 illustrates another block diagram of a system for leveraging generative artificial intelligence and machine learning models to train groups of artificial intelligence models and machine learning models for use in testing, certifying, and deploying ORAN compliant communication network infrastructures, in accordance with various non-limiting example embodiments.

FIG. 4 illustrates a further block diagram of a system for leveraging generative artificial intelligence and machine learning models to train groups of artificial intelligence models and machine learning models for use in testing, certifying, and deploying ORAN compliant communication network infrastructures, in accordance with various non-limiting example embodiments.

FIG. 5 illustrates yet a further block diagram of a system for leveraging generative artificial intelligence and machine learning models to train groups of artificial intelligence models and machine learning models for use in testing, certifying, and deploying ORAN compliant communication network infrastructures, in accordance with various non-limiting example embodiments.

FIG. 6 depicts an overview of the process for leveraging generative artificial intelligence and machine learning models to train groups of artificial intelligence models and machine learning models for use in testing, certifying, and deploying ORAN compliant communication network infrastructures, in accordance with various non-limiting example embodiments.

FIG. 7 depicts an illustrative testing framework for leveraging generative artificial intelligence and machine learning models to train groups of artificial intelligence models and machine learning models for use in testing, certifying, in accordance with various non-limiting example embodiments.

FIG. 8 illustrates a methodology that can be used to leverage generative artificial intelligence and machine learning models to train groups of artificial intelligence models and machine learning models for use in testing, certifying, and deploying ORAN compliant communication network infrastructures, in accordance with various non-limiting example embodiments.

FIG. 9 illustrates an elastic cloud storage (ECS) system, in accordance with various non-limiting example embodiments.

FIG. 10 illustrates a block diagram representing an illustrative non-limiting computing system or operating environment in which one or more aspects of various non-limiting embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

The open radio access network (ORAN) framework seeks to overcome the current issues with extant radio access networks (RANs), wherein disparate network equipment sourced from differing network equipment manufacturer/vendor entities are invariably incompatible with one another. ORAN enables mobile network operator entities (MNOs) to mix-and-match networking equipment from disparate network equipment manufacturer/vendor entities. For example, obtaining first networking equipment from a first network equipment manufacturer/vendor entity and further obtaining second network equipment from an unrelated second network equipment manufacturer/vendor. To achieve and gain benefit of seamless interoperability, compatibility, inter-functionality, and/or the attendant advantages of an ORAN based networking architecture, all component networking equipment in the ORAN arena need to comply with the entire suite of test cases comprising the ORAN technical standard. Each and every network equipment component included in an ORAN network infrastructure must demonstrably satisfy the groups of tests cases outlined and defined in the ORAN technical standards. There are numerous multitudes of tests cases in the current ORAN technical standards that every network component must satisfy in order to be ORAN compliant and the test cases can differ markedly depending on the networking equipment component being tested. Further, the ORAN technical standards are still evolving, and as such additional test cases are constantly being incorporated into the still developing ORAN technical standard,

Each test case of the multitude of tests cases included in, and supplied by, the ORAN technical standard is typically structured in a similar manner: a section providing a description and applicability associated with the test case at issue; a setup and configuration section; a procedure section; and an expected results section. Moreover, the ORAN technical standard requires that each test case be implemented and tested individually, for example, by a networking testing team that can include network engineering identities.

Implementing and testing each test case included in an already expansive ORAN suite of technical standards, prior to launching ORAN compliant networking infrastructures and associated component equipment, can be extremely time-consuming, necessitating vast expenditures of man hours to fulfill all requirements included in the entire suite of ORAN test cases, as set forth in the still emergent ORAN technical standard. In instances where component networking equipment is facilitated and/or effectuated via software in execution on physical hardware equipment, the complexities associated with compliance with suites of relevant ORAN test cases can balloon exponentially as a function of the complexities associated with software in execution. In addition, implementing and testing required test cases and implementing a viable conforming ORAN end-to-end networking infrastructure can be an extremely expensive, tedious, time consuming endeavor, particularly where groups of test cases may require manual implementation and/or intervention. Further, manual implementation and testing can be extremely inefficient, as each test case in the suites of ORAN test cases can be subject to multiple diverse, and many times erroneous, interpretations, thereby compounding the wastage of scarce resources (e.g., man hours, monetary resources, and unneeded time delays in implementation). Subjective interpretations of the requirements imposed by test cases can lead to false positives which can be costly to remedy and/or rectify, particularly when root cause analysis is required to backtrack through countless “correctly” satisfied test cases (e.g., test cases that were, at the time believed to have correctly satisfied test cases) to identify sources of the false positives, and thereafter re-execute the relevant test cases from the determined point(s) of failure to the point at which the misinterpretation of the test case requirements was detected/determined. Moreover, given the comprehensive nature and immense quantities of test cases that need to be complied with in order to certify the entirety of network components as being compliant with an end-to-end ORAN networking architecture, manually testing all possible networking equipment and networking equipment combinations that can comprise a fully compliant end-to-end ORAN networking infrastructure can be overwhelming and infeasible for testing engineers having extremely limited amounts of time.

The subject matter detailed herein can provide appreciable improvements over the current state of the technical field. The described systems and methods can: significantly reduce the time needed to test, end-to-end, an ORAN architecture, this is particularly so for complex software systems; and substantially reduce costs associated with creating/developing an ORAN infrastructure in order to test each and every test case required by the ORAN technical standards. Moreover, since the ORAN technical standards and the test cases therein can be open for differences in interpretation and the human errors that can emanate there from, this disclosure can standardize each test case to better adhere and conform to the ORAN technical standards, leading to fewer false positives that can be costly to remedy and/or correct since an error that occurs in an earlier “successfully” evaluated test case can have significant consequential and varied knock-on impacts on the correct execution and/or evaluation of subsequent test cases-requiring rigorous multiple root cause analyses, backtracking to identify the source of error(s) and the subsequent re-execution of each and every test case from the source point of the identified failure to the point at which the error was identified. Additionally, the described subject matter can appreciably expedite the testing of test cases since erroneous interpretations and historical test case failures that have been unsuccessful in the past can be utilized to train and tune defined artificial intelligence models and/or defined machine learning models created and described herein. Accordingly, network testing engineers are not destined to inadvertently recreate and repeat the failures of the past; thereby reducing the man hours expended, reducing the computational hours used, prevent the wastage of other utilized resources, and decrease the various costs required to certify an end-to-end ORAN infrastructure in accordance with ORAN technical standards.

The disclosed systems and methods, in accordance with various embodiments, provide a system, apparatus, or device comprising: a processor; and a memory that stores executable instructions that, when executed by the processor, facilitate performance of operations. The operations can comprise: receiving, from database equipment, structured test case data of a collection of structured test case data, transforming each structured test case data comprising the collection of structured test case data into a generic executable programming language code representation of the structured test case data, wherein the transforming comprises using a generative artificial intelligence model developed based on a large language model that has been trained using a representative sample collection of the structured test case data, and wherein the representative sample collection of the structured test case data is based on feedback data associated with a previous iterative execution of the generative artificial intelligence model, and executing the generic executable programming language code using a machine language operations pipeline to ensure that network equipment complies with a specified networking protocol standard.

Concerning the foregoing the specified network protocol standard can be an open radio access network protocol, and the structured test case data can be text data that can have been formatted according to a formatting standard comprising, for example, a text title of a function associated with a text description of the function, wherein the text description outlines a group of functional acts needed to ensure compliance of the network equipment to operate within an open radio access network protocol communication system.

Further, the network equipment can be at least one of base station equipment, internet of things equipment, a user equipment such as home based network router equipment, home based access point equipment, commercial femtocell equipment, commercial equipment associated with the cellular structure of a wireless and/or wired mobile network operator entity, and/or satellite based equipment.

Additionally, the executable programming language code can be a conversion of each of the structured test case data represented in text format to a high-level general-purpose programming language representation of each of the structured test case data, and the generative artificial intelligence model can translate keywords included in each of the structured test case data based on a first library of keywords associated with a generic executable programming language specification, and a second library of statistical occurrence associations of the keywords in the generic executable programming language specification.

Moreover, the generative artificial intelligence model can use a word to vector process to obtain a vector representation of each keyword included in the first library of keywords associated with the generic executable programming language specification, wherein the vector representation comprises a group of number values corresponding to each keyword. In addition, the group of number values corresponding to each keyword captures a relationship between a first keyword included in the first library of keywords and a second keyword included in the first library of keywords.

In some instances, the network equipment can be first network equipment, wherein compliance with the specified networking protocol standard comprises operations for determining that the first network equipment is interoperable with second network equipment, and wherein the first network equipment can have been manufactured by a first manufacturing entity and the second network equipment can have been manufactured by a second manufacturing entity.

In accordance with further embodiments, the subject disclosure describes a method, comprising sequences of acts that can include: transforming, by a device comprising at least one or more processor, each structured test case data of a collection of structured test case data into a generic executable programming language code representation of the structured test case data, wherein each structured test case data of the collection of structured test case data can have been received from a database of a group of databases, and executing, by the device, the generic executable programming language code using a machine language operations pipeline to ensure that network equipment representing a testing framework of networking equipment complies with a specified networking protocol standard.

Other acts can include using, by the device, a generative artificial intelligence model developed based on a large language model that has been trained using a representative sample collection of the structured test case data to transform each structured test case data included in the collection of structured test case data into a generic executable programming language code representation of the structured test case data. The representative sample collection of the structured test case data can be based on feedback data associated with a previous iterative execution of the generative artificial intelligence model. Additionally, in order to transform each structured test case data included in the collection of structured test case data into a generic executable programming language code representation of the structured test case data a natural language processing machine learning model can be used to convert the generic executable programming language code into the testing framework, wherein the natural language processing machine learning model can have been trained using feedback received in response to executing the generic executable programming language code in the testing framework.

In accordance with still further embodiments, the subject disclosure describes a machine-readable storage medium, a computer readable storage device, or non-transitory machine-readable media comprising instructions that, in response to execution, cause a computing system comprising at least one processor to perform operations. The operations can comprise: in response to receiving, from database equipment of a group of database equipment, structured test case data of a group of structured test case data, transforming the structured test case data of the collection of structured test case data into a generic executable programming language code representative of the structured test case data, and executing the generic executable programming language code using a machine language operations pipeline to ensure that network equipment represented in a testing framework of networking equipment complies with a specified networking protocol standard. The structured test case data can be text data that can have been formatted according to a formatting standard comprising a text title of a function associated with a text description of the function, wherein the text description can outline a grouping of functional acts required to ensure compliance of the network equipment to operate within an open radio access network protocol communication system.

In connection with the foregoing, the executable programming language code can be a conversion of each of the structured test case data represented in text format to a high-level general-purpose programming language representation of each of the structured test case data. Also, the transforming can comprise using natural language processing machine learning models to convert the generic executable programming language code into the testing framework.

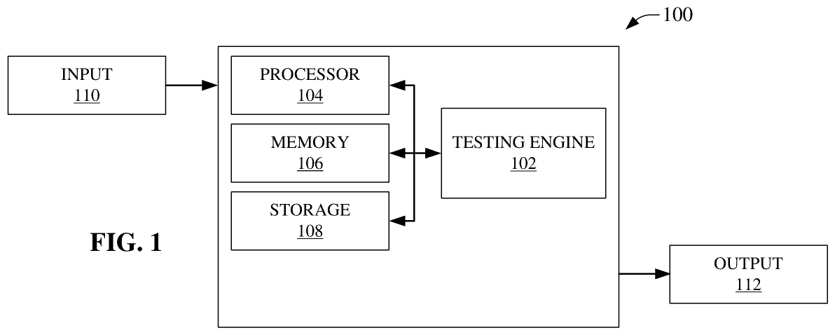

Now in reference to the Figures. FIG. 1 depicts a system 100 that can leverage generative artificial intelligence and machine learning models to train groups of artificial intelligence models and machine learning models for use in testing and deploying ORAN compliant communication network infrastructures, in accordance with various example embodiments. System 100, for purposes of illustration, can be any type of mechanism, machine, device, facility, apparatus, and/or instrument that includes a processor and/or is capable of effective and/or operative communication with a wired and/or wireless network topology. Mechanisms, machines, apparatuses, devices, facilities, and/or instruments that can comprise system 100 can include tablet computing devices, handheld devices, server class computing equipment, machines, and/or database equipment, laptop computers, notebook computers, desktop computers, cell phones, smart phones, consumer appliances and/or instrumentation, industrial devices and/or components, hand-held devices, personal digital assistants, multimedia Internet enabled phones, Internet of Things (IoT) equipment, multimedia players, and the like.

System 100 can comprise testing engine 102 that can be in operative communication with processor 104, memory 106, and storage 108. testing engine 102 can be in communication with processor 104 for facilitating operation of computer-executable instructions or machine-executable instructions and/or components by testing engine 102; memory 106 for storing data and/or computer-executable instructions and/or machine-executable instructions and/or components; and storage 108 for providing longer term storage of data and/or machine-readable instructions and/or computer-readable instructions. Additionally, system 100 can also receive input 110 for use, manipulation, and/or transformation by testing engine 102 to produce one or more useful, concrete, and tangible result, and/or transform one or more articles to different states or things. Further, system 100 can also generate and output the useful, concrete, and tangible result and/or the transformed one or more articles as output 112.

System 100 in conjunction with testing engine 102 can receive, as input 110, structured test case data of a collection of structured test case data. The structured test case data can be text data that can be formatted according to a format standard comprising, for example, a text title of a function associated with a text description of the function, wherein the text description outlines a group of functional acts needed to ensure compliance of network equipment to operate within an open radio access network protocol wireless and/or wired communications system. Testing engine 102, in response to receiving the structured test case data can transform each test case data of the collection of structure test case data into a generic executable programming language. Transforming the structured test case data to a generic executable programming language can comprise using one or more generative artificial intelligence models that can have been trained, tuned, and developed based on a large language model.

Training, tuning, and developing the one or more generative artificial intelligence models can be accomplished, by testing engine 102, using representative sample collections of structured test case data. Initially when the generative artificial intelligence models are being developed representative sample collections of structured test case data can be based on a selection of structured test case data that has been identified by one or more human intermediary identities (e.g., network testing engineers conversant in the ORAN technical standards and/or the requirements needed to certify an array of disparate networking equipment as being compliant with the ORAN technical standards). Once initial artificial intelligence models have been trained using the selection of structured test case data identified human intermediaries, the initial artificial intelligence models can be further tuned using a verification dataset of test case data. The verification dataset of test case data, for example, can be a group of structured test case data that has manually been transformed from structured test data to generic executable programming language. As will be appreciated, at the initial stages of the developing the artificial intelligence models there can be many errors that can occur, and as such these errors can be corrected by network testing engineers and supplied, as feedback data, to the developing generative artificial intelligence models. With each subsequent iteration and further tuning and/or retraining of the developing generative artificial intelligence models based on, and/or in response to the feedback data, the generative artificial intelligence models can evolve and become much more accurate in their ability to transform structured test data to generic executable programming language code.

Once the one or more generative artificial intelligence modes have been satisfactorily refined and tuned, testing engine 100 can receive production structured test case data, for example from a group of database equipment that persists in text form. The production structure test case data can be collections of test cases that can comprise test cases included in the ORAN technical specifications (e.g., promulgated by the ORAN Test and Implementation Focus Group (TIFG)). As noted earlier, the technical body controlling global implementation and introduction of the ORAN facilities and/or functionalities requires that all networking equipment such as base station equipment, switching equipment, router equipment, . . . . Such equipment can include: ORAN radio unit (RU) equipment that can handle the encoding/decoding/modulation/transmission of radio signals; ORAN distribution unit (DU) equipment that can be a logical node hosting radio link control (RLC) layers/medium access control (MAC) layers/High-physical High-PHY layers based on one or more lower layer functional split-ORAN DU equipment can host management plane (M-Plane) instances; ORAN central unit (CU) equipment that can be one or more logical node hosting packet data convergence protocol (PDCP) functions, radio resource control (RRC) functions, service data adaptation protocol (SDAP) functions, as well as other control functions.

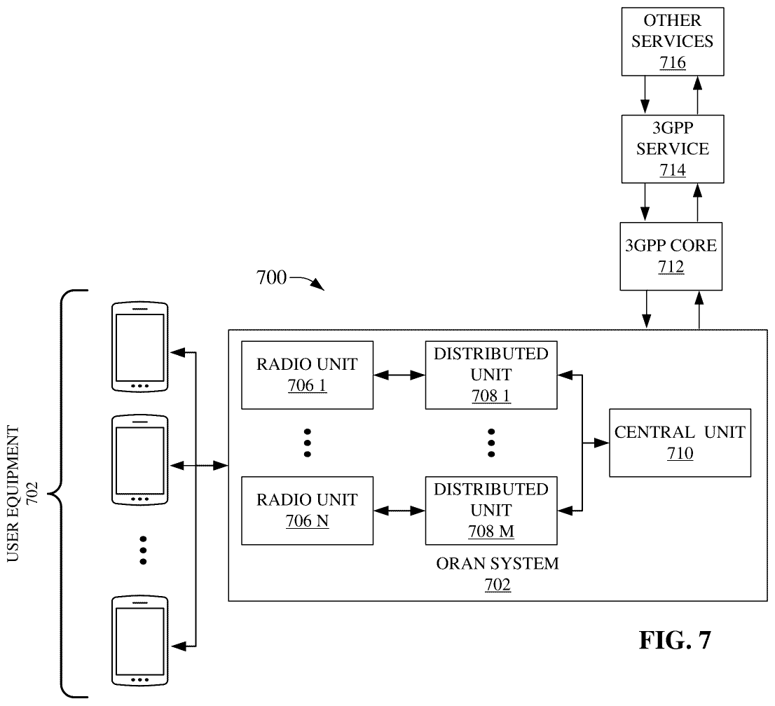

In addition to training and using generative artificial intelligence models to accurately translate structured test data represented in a defined or definable text format into viable accurate representations of executable programming code, such as executable and generic Python programming language code, in some embodiments, can be conveyed to one or more natural language processing machine learning models. The natural language processing machine learning models can translate generic executable programming code for execution in a desired testing framework (see e.g., FIG. 7 for an example testing framework). In order to effectuate the creation, development, and training of the natural language processing machine learning models testing engine 102 can follow a pattern of training similar to that outlined above in connection with creating, developing, training, and ultimately placing into production the generative artificial intelligence models. To reprise, testing engine 102 can create and initialize the natural language processing machine learning models by using a manually selected representative first sampling of generic executable programming code-testing group of generic executable programming code. Once the natural language processing machine learning models have been created and initially developed testing engine 102, to gain better accuracy, can further develop the natural language processing machine learning models by using a second sampling of generic executable programming code-verification group of generic executable programming code together with feedback from one or more human intermediaries (e.g., network testing engineer identities). Once the natural language processing machine learning models have been satisfactorily developed and trained, the natural language processing machine learning models can be placed into production by testing engine 102, wherein the natural language processing machine learning models can be applied against incoming generic executable programming code for translation to a desired testing framework.

In some embodiments the natural language processing machine learning models utilized by testing engine 102 can be a word to vector model that can translate the generic executable programming code into a desired testing framework, whereupon cosine similarities between vectors can be determined in order to identify translation confidence values (e.g., matching words associated a highest/maximum similarity confidence value). As will be appreciated by persons skilled in the art the translation confidence values can be applied against threshold translation confidence values in order to determine whether or not the translation, by the developed natural language processing machine learning models, meet expectations in regard to the translation. In regard to the translation of the generic executable programming code into a desired testing framework, semantic and/or syntactic similarities can be taken into consideration both while developing and training natural language processing machine learning models, and when the trained natural language processing machine learning models are placed into a production environment (e.g., when the details and embodiments included in this disclosure are used, for instance, by MNOs to transform and configure their existing wireless/wired communication infrastructures to include networking equipment and technologies that comply with the ORAN standards).

Testing engine 102 can also provide a feedback dashboard that can be used by network testing engineering identities to provide feedback for the further training and refinement of the generative artificial intelligence models as well as the natural language processing machine learning models. Using the feedback dashboard, network testing engineering identities can label defined or definable keywords associated with the generative artificial intelligence models and/or the natural language processing machine learning models respectively associated with converting structured test case data represented in text format to a generic executable programming language and/or translating generic executable programming language to a desired testing framework. Typically the labels with which the defined and/or definable keywords can be associated can be a defined group of labels. For instance and in some embodiments, the defined group of labels can comprise first labels that indicate that the generic programming language code generated and output as a function of the generative artificial intelligence models is “correct.” Similarly in other additional and/or alternative embodiments, the defined group of labels can also comprise second labels that can indicate that the translation, via the trained natural language processing machine learning models, of the generic executable programming code to testing framework is “correct.” In some additional and/or alternative embodiments, other labels comprising the defined group of labels can include third labels indicative of a “generative artificial intelligence model translation error.” In still yet further additional and/or alternative embodiments, the defined group of labels can comprise fourth labels that can provide indication that there has been a “natural language processing machine learning model error.” Furthermore, in additional and/or alternative embodiments, the defined group of labels can comprise fifth labels that can provide feedback data in relation to an “unavailability in the testing framework.” As will be appreciated by persons having ordinary skill in the art, additional and/or alternative labels, depending on defects or shortcoming in either the generative artificial intelligence models and/or the natural language processing machine learning models, can also be included in the group of labels. Each label in the group of labels can be used to adapt and refine each of the models (e.g., generative artificial intelligence models and/or the natural language processing machine learning models.

Testing engine 102 can also provide functionalities and/or facilities associated with an automated MLOPs pipeline that can generate all the desired test cases included in the ORAN testing documentation. The MLOPs pipeline can be responsible for integrating each of the test cases in the testing environments. Generally, the MLOPs can execute all the test cases and can report the output/results of each execution of a test case. In connection with MLOPs, MLOPs is a process for deploying and reliably and efficiently maintaining machine learning models (e.g., the described natural language processing machine learning models). MLOPs is a portmanteau for the words “machine learning” (ML) and the continuous development (practice of DevOps (e.g., software development (Dev) and information technology operations (Ops)).

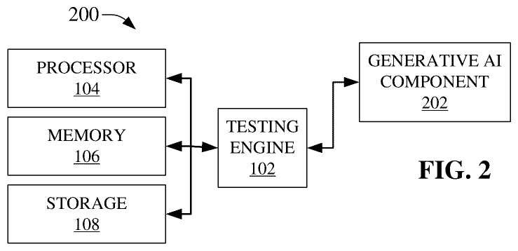

FIG. 2 provides additional illustration of a system 100 (now depicted as system 200) that can leverage generative artificial intelligence and machine learning models to train groups of artificial intelligence models and machine learning models for use in testing and deploying ORAN compliant communication network infrastructures, in accordance with various example embodiments. As illustrated system 200, in addition to testing engine 102, can include generative artificial intelligence (AI) component 202. Generative AI component 202 can initiate and/or instantiate one or more generative artificial intelligence model. Testing engine 102, via use of generative AI component 202 and a curated sample group of structured test case data, can create and/or train the one or more artificial intelligence model to translate a stream of incoming structured test case data from a structured text format to a generic programming language script. The training of the one or more artificial intelligence model can entail repeatedly using disparate groups of feedback data, such as a group of verification structured test case data and/or the use of data that can have been generated and returned when the one or more artificial intelligence model has been placed into a testing environment and/or a production environment. Each iterative execution of the one or more artificial intelligence model using training data (e.g., curated sample groups of structured test case data, verification data comprising other groupings of sampled structure test case data, and/or feedback data received from a feedback component, wherein a human intermediary assesses the accuracy of the conversion of the structure test case data to generic programming language code data) can refine and tune the artificial intelligence model to better analyze and convert incoming structure test case data to generic programming language code/script.

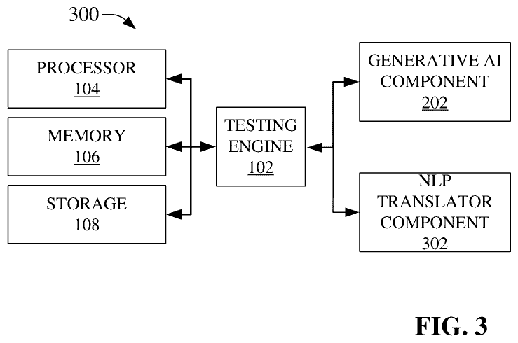

FIG. 3 provides additional illustration of system 200 (now depicted as system 300) that can leverage generative artificial intelligence and machine learning models to train groups of artificial intelligence models and machine learning models for use in testing and deploying ORAN compliant communication network infrastructures, in accordance with various example embodiments. As illustrated testing engine 102, in collaboration with natural language processing (NLP) translation component 302, can create, initialize, and fine tune one or more natural language processing machine learning models. As has been noted earlier, the creation, initialization, and/or the refinement of the one or more NLP machine learning models can follow a pattern of training and fine tuning similar to that described in connection with the one or more generative artificial intelligence models. Once the one or more NLP machine learning models have been satisfactorily refined and developed by NLP translation component 302, the one or more NLP machine learning models can be placed into a production environment, wherein the one or more NLP machine learning models can be utilized to translate the generic executable programming code (e.g., that can have been generated based on feeding a stream of structured test data to the one or more generative artificial intelligence models in order to reliably convert the oncoming stream of structured test data to a generic executable programming code representative of the stream of structured test data) to a desired testing framework.

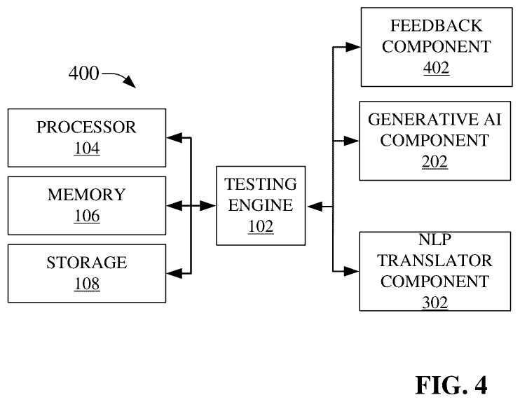

FIG. 4 provides further depiction of system 300 (now depicted as system 400) that can leverage generative artificial intelligence and machine learning models to train groups of artificial intelligence models and machine learning models for use in testing and deploying ORAN compliant communication network infrastructures, in accordance with various example embodiments. System 400, in addition to testing engine 102, generative AI component 202, and NLP translation component 302, can include feedback component 402. Feedback component 402 can provide a feedback dashboard that can be used by network testing engineering identities (e.g., human intermediaries and/or artificial intelligence models representing human intermediaries) to provide feedback for the further refinement and training associated with both the generative artificial intelligence models and the natural language processing machine learning models. Through use of a feedback dashboard network testing engineering identities can assess and classify the testing framework that can be an end result of feeding streams of structured test data to generative artificial intelligence models in order to transform the streams of structured test data to one or more testing framework. In many embodiments the flashback component 402 can display the flashback dashboard on a device comprising at least a display.

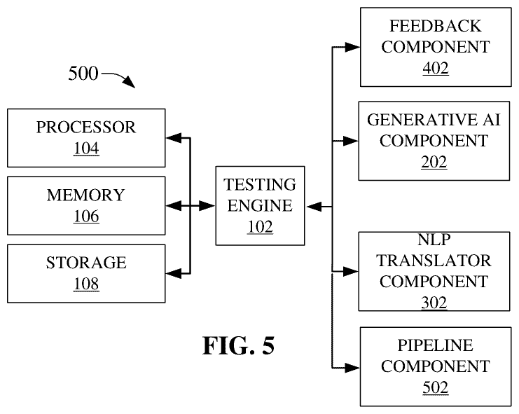

FIG. 5 provides additional illustration of system 400 (now depicted as system 500) that can leverage generative artificial intelligence and machine learning models to train groups of artificial intelligence models and machine learning models for use in testing and deploying ORAN compliant communication network infrastructures, in accordance with various example embodiments. System 500 depicts pipeline component 502 that individually and/or in conjunction with generative AI component 202, NLP translator component 302, and feedback component 402, can provide facilities and/or functionalities associated with a MLOPs pipeline. The MLOPs pipeline can generate and execute all the desired test cases in the ORAN testing documentation, the MLOPs pipeline can be responsible for integrating each of the test cases in a testing environment (e.g., testing framework). The MLOPs pipeline provided by pipeline component 502 can execute the generic programming language code within the testing framework in order to certify that the entirety of networking equipment included in the testing framework comply with the ORAN standard.

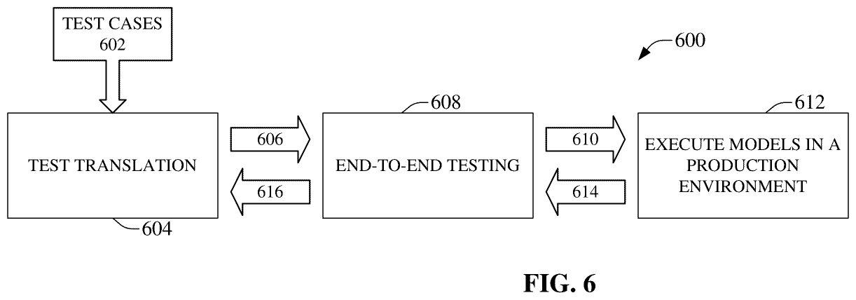

FIG. 6 provide an overview illustration of a system 600 that can leverage generative artificial intelligence and machine learning models to train groups of artificial intelligence models and machine learning models for use in testing and deploying ORAN compliant communication network infrastructures, in accordance with various example embodiments.

As depicted in system 600 a test translation embodiment 604 can receive as input structured test case data of a collection of structured test case data 602. As observed earlier, the structured test case data 602 can be text data that can be formatted according to a formatting standard comprising: a text title of a function associated with a text description of the function, wherein the text description outlines a group of functional acts needed to ensure compliance of network equipment to operate within an ORAN wireless and/or wired communications system. Test translation 604, in response to receiving the structured test case data can transform each test case data of the collection of structure test case data 602 into a generic executable programming language. Transforming the structured test case data to a generic executable programming language can comprise using one or more generative artificial intelligence models that can have been trained, tuned, developed by test translation 604 based on a large language model.

Training, tuning, and developing the one or more generative artificial intelligence models can be accomplished, by cycling between transition 606 and transition 616 and utilizing test translation 604 and end-to-end testing 608, using representative sample collections of structured test case data. Initially when generative artificial intelligence models are being developed representative sample collections of structured test case data can be based on a selection of structured test case data that has been identified, for instance, by one or more human intermediary identities. Once initial artificial intelligence models have been trained using the selection of structured test case data, the initial artificial intelligence models can be further tuned, by cycling between transition 606 and transition 615 and employing test translation 604 and end-to-end testing 608, using a verification dataset of test case data. The verification dataset of test case data, for example, can be a group of structured test case data that can have been manually (e.g., by a human identity) been transformed from structured test data to generic executable programming language data. As will be appreciated, at the initial stages of the developing the artificial intelligence models there can be many errors that can occur, and as such these errors can be corrected by network testing engineers and supplied, as feedback data (e.g., transitions 606, 610, 614 and 616), to the developing generative artificial intelligence models. With each subsequent iteration and further tuning and/or retraining of the developing generative artificial intelligence models based on, and/or in response to the feedback data (e.g., cycling between testing translation 604, end-end testing 608 and/or eventually feedback received from executing the developed generative artificial intelligence models and NLP machine learning models 612, via transitions 606, 620, 614, and 616), the generative artificial intelligence models can evolve and become much more accurate in their ability to transform structured test data to generic executable programming language code.

Once the one or more generative artificial intelligence modes have been satisfactorily refined and tuned, test translation 604 can commence receiving real-time production structured test case data, for example from a group of database equipment that persists the real-time production structured test case data in representative text form. The real-time production structure test case data can be collections of test cases that can comprise test cases included in the ORAN technical specifications (e.g., promulgated by the ORAN Test and Implementation Focus Group (TIFG)).

In addition to training and using generative artificial intelligence models to accurately translate structured test data represented in a defined or definable text format into viable accurate representations of executable programming code, such as executable and generic Python programming language code, in some embodiments, can be conveyed to one or more natural language processing machine learning models. The natural language processing machine learning models can translate generic executable programming code for execution to a desired testing framework. In order to effectuate the creation, development, and training of the natural language processing machine learning models test translation 604 can follow a pattern of training similar to that outlined above in connection with creating, developing, training, and ultimately placing into production the generative artificial intelligence models.

In some embodiments the natural language processing machine learning models utilized by test translation 604, end-to-end testing 608, and/or executing both the developed generative artificial intelligence models and NLP machine learning models 612, can be a word to vector model that can translate the generic executable programming code into a desired testing framework, whereupon cosine similarities between vectors can be determined in order to identify translation confidence values (e.g., matching words associated a highest/maximum (and/or lowest/minimal) similarity confidence value). As will be appreciated by persons skilled in the art the translation confidence values can be applied against determinable threshold translation confidence values in order to determine whether or not the translation, by the developed natural language processing machine learning models, meet expectations in regard to the translation. In regard to the translation of the generic executable programming code into a desired testing framework, semantic and/or syntactic similarities can be taken into consideration both while developing and training natural language processing machine learning models, and when the trained natural language processing machine learning models are placed into a production environment 612.

Test translation 604 can also provide a feedback dashboard that can be used by network testing engineering identities to provide feedback (e.g., acts 614 and 616) for the further training and refinement of the generative artificial intelligence models as well as the natural language processing machine learning models. Using the feedback dashboard, network testing engineering identities can label defined or definable keywords associated with the generative artificial intelligence models and/or the natural language processing machine learning models respectively associated with converting structured test case data represented in text format to a generic executable programming language and/or translating generic executable programming language to a desired testing framework. Typically the labels with which the defined and/or definable keywords can be associated can be a defined group of labels. For instance and in some embodiments, the defined group of labels can comprise first labels that indicate that the generic programming language code generated and output as a function of the generative artificial intelligence models is “correct.” Similarly in other additional and/or alternative embodiments, the defined group of labels can also comprise second labels that can indicate that the translation, via the trained natural language processing machine learning models, of the generic executable programming code to testing framework is “correct.” In some additional and/or alternative embodiments, other labels comprising the defined group of labels can include third labels indicative of a “generative artificial intelligence model translation error.” In still yet further additional and/or alternative embodiments, the defined group of labels can comprise fourth labels that can provide indication that there has been a “natural language processing machine learning model error.” Furthermore, in additional and/or alternative embodiments, the defined group of labels can comprise fifth labels that can provide feedback data in relation to an “unavailability in the testing framework.” As will be appreciated by persons having ordinary skill in the art, additional and/or alternative labels, depending on defects or shortcoming in either the generative artificial intelligence models and/or the natural language processing machine learning models, can also be included in the group of labels. Each label in the group of labels can be used to adapt and refine each of the models (e.g., generative artificial intelligence models and/or the natural language processing machine learning models.

In regard to the generic programming language code disclosed herein, example generic programming language code can, for example, include the Python programming language, R programming language, LISP programming language, Perl programming language, Smalltalk programming language, object oriented programming language, C, C++, Java, Java script, and the like,

With reference to FIG. 7 that depicts an illustrative testing framework 700. The disclosed testing framework 700, and once implementation of the ORAN system is eventually implemented by MNOs, can comprise a collection of user equipment 704, such as Smartphone devices, cellular mobile equipment, laptop computers, internet of things (IoT) equipment, commercial equipment comprising at least one processor and one or more memory, home electronic equipment including one or more processor and at least one memory, and the like. Also depicted in FIG. 7 in the context of the testing framework 700 is ORAN system 702, ORAN system 702 can be disposed within a MNO's wired and/or wireless communication network between the collection of user equipment 704 and an extant 3GPP core 712, which can be communicative coupled to one or more current 3GPP service 714, and/or other services 716 that can typically be provided by MNOs.

The ORAN system 702 can comprise one or more ORAN radio unit (RU) 706_1 . . . 706_N and one or more ORAN distributed unit (DU) 708_1 . . . 708_M, wherein N and M represent an integer values greater than 0, and wherein the values of N and M need not be correspondent with one another. In some embodiments there can be more ORAN radio units 706_1 . . . 706_N than ORAN distributed units 708_1 . . . 708_M, while in other alternative and/or additional embodiments, there can be a greater number of ORAN distributed units 708_1 . . . 708_M than ORAN radio units 706_1 . . . 706_N. In further additional and/or alternative embodiments the number of ORAN radio units 706_1 . . . 706_N can correspond and/or mirror the number of ORAN distribution units 708_1 . . . 708_M. As illustrated, ORAN radio units 706_1 . . . 706_N can be operative communication, via wired and/or wired facilities and functionalities, with one or more of the collection of user equipment 704. Further, ORAN radio units 706_1 . . . 706_N can also be communicative coupled to one or more ORAN distributed unit 708_1 . . . 708_M. In some embodiments, more than one ORAN radio unit can be in operable interchange and/or communicatively coupled to a single ORAN distributed unit 708_1 . . . 708_M. In other embodiments, more than one ORAN distributed unit 708_1 . . . 708_M can be serving a single ORAN radio unit 706_1 . . . 706_N. Also illustrated in FIG. 7 the ORAN distribution units 708_1 . . . 708_M can be coupled to ORAN central unit 710, which can then be in communication with 3GPP core 712, 3GPP service 714, and other service 716 aspects of an MNOs extant and operating wireless and/or wired network infrastructure.

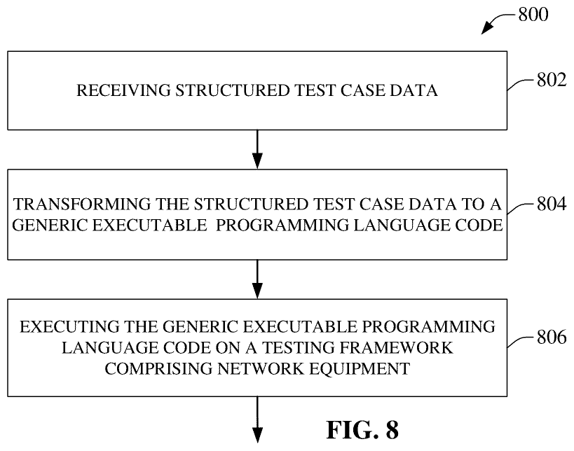

FIG. 8 illustrates a flowchart, time sequence, and/or methodology for performing operations corresponding to systems 100, 200, 300, 400, and 500 in accordance with various example embodiments. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies and/or time sequences in accordance with the disclosed subject matter. In addition, those skilled in the art will understand and appreciate that the time sequences and/or methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 8 depicts a method 800 for leveraging generative artificial intelligence and machine learning models to train groups of artificial intelligence models and machine learning models for use in testing and deploying ORAN compliant communication network infrastructures, in accordance with various example embodiments. The method can commence, at act 802, receiving, from database equipment, structured test case data of a collection of structured test case data. At act 804 each structured test case data comprising the collection of structured test case data can be transformed, using trained generative artificial intelligence models, into a generic executable programming language code representative of the structured test case data, wherein the generic executable programming language code is then translated, using a natural language processing machine language model, to a testing framework. At act 806 the generic executable programming language code conforming to the testing framework can be executed using a machine language operations pipeline to ensure that networking equipment included in the testing network complies with a networking protocol standard.

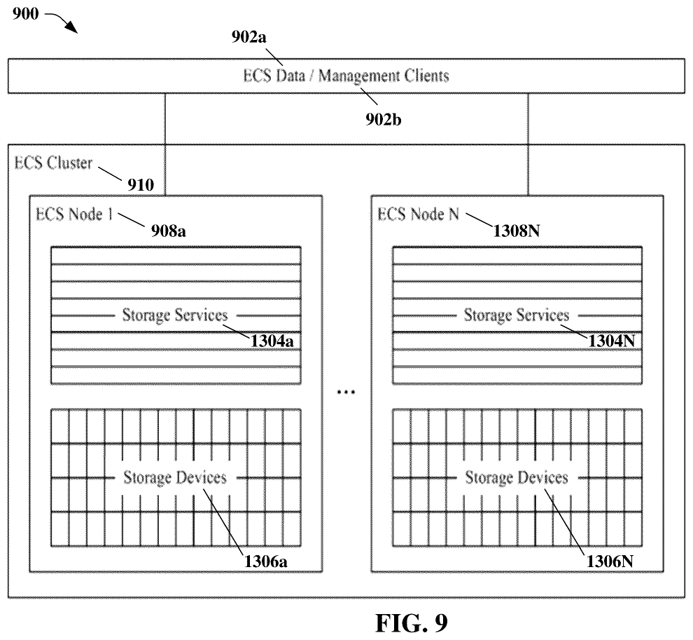

In the following, FIG. 9 describes an example non-limiting cloud storage system in the non-limiting context of an ECS storage system, but for the avoidance of doubt, the subject embodiments can apply to any storage platform. For instance, in this regard, FIG. 9 illustrates an ECS storage system 900 comprising a cloud-based object storage appliance in which corresponding storage control software comprising, e.g., ECS data client(s) 902a, ECS management client(s) 902b, storage service(s) 904a . . . 904N, etc. and storage devices 906a . . . 906N (e.g., storage media, such as physical magnetic disk media, etc. of respective ECS nodes of ECS cluster 910) are combined as an integrated system with no access to the storage media other than through the ECS storage system 900.

In this regard, ECS cluster 910 comprises multiple nodes 908a . . . 908N, storage nodes, ECS nodes, etc. Each node is associated with storage devices 906a . . . 906N, e.g., hard drives, physical disk drives, storage media, etc. In embodiment(s), ECS node 908a, or any ECS node, executing on a hardware appliance can be communicatively coupled, connected, cabled to, etc., e.g., 15 to 120 storage devices. Further, each ECS node can execute one or more services for performing data storage operations described herein.

For instance, the ECS storage system 900 can be an append-only virtual storage platform that protects content from being erased or overwritten for a specified retention period. In particular, the ECS storage system 900 does not employ traditional data protection schemes like mirroring or parity protection. Instead, the ECS storage system 900 utilizes erasure coding for data protection, wherein data, a portion of the data, e.g., a data chunk, is broken into fragments, and expanded and encoded with redundant data pieces and then stored across a set of different locations or storage media, e.g., across different storage nodes.

The ECS storage system 900 can support storage, manipulation, and/or analysis of unstructured data on a massive scale on commodity hardware. As an example, the ECS storage system 900 can support mobile, cloud, big data, and/or social networking applications. In another example, the ECS storage system 900 can be deployed as a turnkey storage appliance, or as a software product that can be installed on a set of qualified commodity servers and disks, e.g., within a node, data storage node, etc. of a cluster, data storage cluster, etc. In this regard, the ECS storage system 900 can comprise a cloud platform that comprises at least the following features: (i) lower cost than public clouds; (ii) unmatched combination of storage efficiency and data access; (iii) anywhere read/write access with strong consistency that simplifies application development; (iv) no single point of failure to increase availability and performance; (v) universal accessibility that eliminates storage silos and inefficient extract, transform, load (ETL)/data movement processes; etc.

In embodiment(s), the cloud-based data storage system can comprise an object storage system, e.g., a file system comprising, but not limited to comprising, a Dell EMC® Isilon file storage system. As an example, a storage engine can write all object-related data, e.g., user data, metadata, object location data, etc. to logical containers of contiguous disk space, e.g., such containers comprising a group of blocks of fixed size (e.g., 128 MB) known as chunks. Data is stored in the chunks and the chunks can be shared, e.g., one chunk can comprise data fragments of different user objects. Chunk content is modified in append-only mode, e.g., such content being protected from being erased or overwritten for a specified retention period. When a chunk becomes full enough, it is sealed, closed, etc. In this regard, content of a sealed, closed, etc. chunk is immutable, e.g., read-only, and after the chunk is closed, the storage engine performs erasure-coding on the chunk.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, the terms “logic,” “logical,” “logically,” and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

As utilized herein, terms “component,” “system,” “engine”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server, client, etc. and the server, client, etc. can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to: random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per sc.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used to determine probabilistic likelihoods that code paths utilize operating system synchronization mechanism, as described herein.

A classifier can be a function that maps an input attribute vector, x=(x1, x2, x3, x4, . . . , xn), to a confidence that the input belongs to a class, that is, f (x)=confidence (class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via observing characteristics of communication equipment, e.g., a server, etc., receiving reports from such communication equipment, receiving operator preferences, receiving historical information, receiving extrinsic information, etc. For example, support vector machines can be configured via a learning or training phase within a classifier constructor and feature selection module. Thus, the classifier(s) can be used by an artificial intelligence system to automatically learn and perform a number of functions, e.g., performed by variance engine 102.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As it is employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “database,” “storage medium,” “socket”, and substantially any other information storage component relevant to operation and functionality of a system, component, and/or process, can refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in a data storage cluster, non-volatile memory 1022, disk storage 1024, and/or memory storage 1046, further description of which is below. For instance, nonvolatile memory can be included in read only memory (ROM), programmable ROM (PROM), electrically programmable ROM (EPROM), electrically erasable ROM (EEPROM), or flash memory. Volatile memory 1020 can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

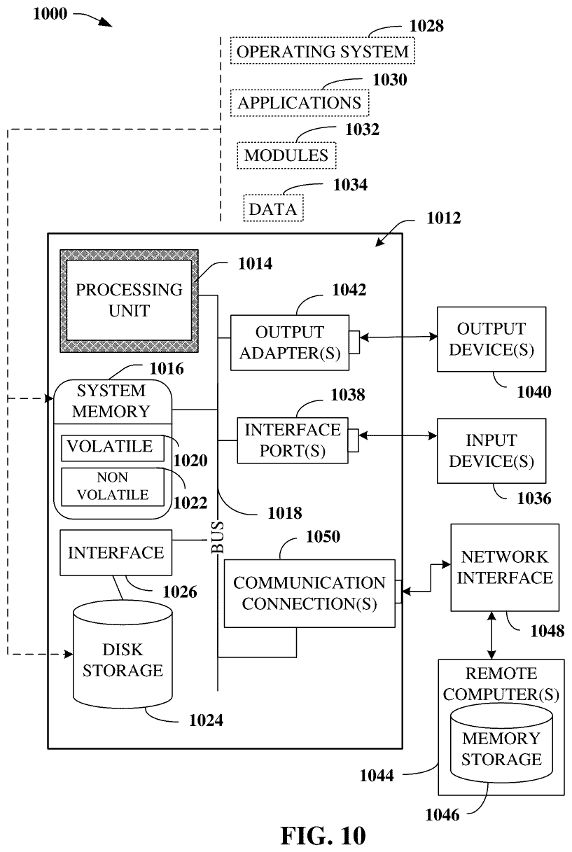

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 10, a block diagram of a computing system 1000, e.g., system 100, operable to execute the disclosed systems and methods is illustrated, in accordance with an embodiment. Computer 1012 comprises a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1016 comprises volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can comprise ROM, PROM, EPROM, EEPROM, or flash memory. Volatile memory 1020 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also comprises removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, Jaz drive, Zip drive, LS-100 drive, flash memory card, or memory stick. In addition, disk storage 1024 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

It is to be appreciated that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be appreciated that the disclosed subject matter can be implemented with various operating systems or combinations of operating systems.

A user can enter commands or information into computer 1012 through input device(s) 1036. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1014 through system bus 1018 via interface port(s) 1038. Interface port(s) 1038 comprise, for example, a serial port, a parallel port, a game port, a universal serial bus (USB), a wireless based port, e.g., Wi-Fi, Bluetooth, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040, like display devices, light projection devices, monitors, speakers, and printers, among other output devices 1040, which use special adapters. Output adapters 1042 comprise, by way of illustration and not limitation, video and sound devices, cards, etc. that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, a workstation, a microprocessor based appliance, a peer device, or other common network node and the like, and typically comprises many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically and/or wirelessly connected via communication connection 1050. Network interface 1048 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and DSL modems, wireless modems, ISDN adapters, and Ethernet cards.

The computer 1012 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1012 can connect to other devices/networks by way of antenna, port, network interface adaptor, wireless access point, modem, and/or the like.

The computer 1012 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating there from. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, comprising:
receiving, from database equipment, structured test case data of a collection of structured test case data;
transforming each structured test case data comprising the collection of structured test case data into a generic executable programming language code representation of the structured test case data, wherein the transforming comprises using a generative artificial intelligence model developed based on a large language model that has been trained using a representative sample collection of the structured test case data, and wherein the representative sample collection of the structured test case data is based on feedback data associated with a previous iterative execution of the generative artificial intelligence model; and
executing the generic executable programming language code using a machine language operations pipeline to ensure that network equipment complies with a specified networking protocol standard.

2. The system of claim 1, wherein the specified network protocol standard is an open radio access network protocol.

3. The system of claim 1, wherein the structured test case data is text data that is formatted according to a formatting standard comprising a text title of a function associated with a text description of the function, and wherein the text description outlines a group of functional acts necessary to ensure compliance of the network equipment to operate within an open radio access network protocol communication system.

4. The system of claim 1, wherein the network equipment comprises at least one of base station equipment, internet of things equipment, a user equipment, or satellite based equipment.

5. The system of claim 1, wherein the executable programming language code is a conversion of each of the structured test case data represented in text format to a high-level general-purpose programming language representation of each of the structured test case data.

6. The system of claim 1, wherein the generative artificial intelligence model translates keywords included in each of the structured test case data of the collection of structured test case data based on a first library of keywords associated with a generic executable programming language specification and a second library of statistical occurrence associations of the keywords in the generic executable programming language specification.

7. The system of claim 6, wherein the generative artificial intelligence model uses a word to vector process to obtain a vector representation of each keyword included in the first library of keywords associated with the generic executable programming language specification, and wherein the vector representation comprises a group of number values corresponding to each keyword.

8. The system of claim 7, wherein the group of number values corresponding to each keyword captures a relationship between a first keyword included in the first library of keywords and a second keyword included in the first library of keywords.

9. The system of claim 1, wherein the network equipment is first network equipment, and wherein compliance with the specified networking protocol standard comprises determining that the first network equipment is interoperable with second network equipment.

10. The system of claim 8, wherein the first network equipment is manufactured by a first manufacturing entity and the second network equipment is manufactured by a second manufacturing entity.

11. A method, comprising:
transforming, by a device comprising one or more processor, each structured test case data of a collection of structured test case data into a generic executable programming language code representation of the structured test case data, wherein each structured test case data of the collection of structured test case data is received from a database of a group of databases; and
executing, by the device, the generic executable programming language code using a machine language operations pipeline to ensure that network equipment representing a testing framework of networking equipment complies with a specified networking protocol standard.

12. The method of claim 11, wherein the transforming comprises using, by the device, a generative artificial intelligence model developed based on a large language model that has been trained using a representative sample collection of the structured test case data.

13. The method of claim 12, wherein the representative sample collection of the structured test case data is based on feedback data associated with a previous iterative execution of the generative artificial intelligence model.

14. The method of claim 11, wherein the transforming comprises using, by the device, a natural language processing machine learning model to convert the generic executable programming language code into the testing framework.

15. The method of claim 14, wherein the natural language processing machine learning model is trained using feedback received in response to executing the generic executable programming language code in the testing framework.

16. A non-transitory machine-readable medium comprising instructions that, in response to execution, cause a system comprising at least one processor to perform operations, comprising:
in response to receiving, from database equipment of a group of database equipment, structured test case data of a group of structured test case data, transforming the structured test case data of the collection of structured test case data into a generic executable programming language code representative of the structured test case data; and
executing the generic executable programming language code using a machine language operations pipeline to ensure that network equipment represented in a testing framework of networking equipment complies with a specified networking protocol standard.

17. The non-transitory machine-readable medium of claim 16, wherein the structured test case data is text data that is formatted according to a formatting standard comprising a text title of a function associated with a text description of the function, and wherein the text description outlines a group of functional acts required to ensure compliance of the network equipment to operate within an open radio access network protocol communication system.

18. The non-transitory machine-readable medium of claim 16, wherein the network equipment is first network equipment, and wherein compliance with the specified networking protocol standard comprises determining that the first network equipment is interoperable with second network equipment.

19. The non-transitory machine-readable medium of claim 16, wherein the executable programming language code is a conversion of each of the structured test case data represented in text format to a high-level general-purpose programming language representation of each of the structured test case data.

20. The non-transitory machine-readable medium of claim 16, wherein the transforming comprises using a natural language processing machine learning model to convert the generic executable programming language code into the testing framework.
